(19) United States
(12) Patent Application Publication
(10) Pub. No.: US 2010/0005949 A1
(43) Pub. Date: Jan. 14, 2010

(54) Tuner with clothes-pin design

(76) Inventor: John Paul Calcagnini, Redondo Beach, CA (US)

Correspondence Address: John Calcagnini, 2407 Vail Avenue, Redondo Beach, CA, 90278, US

(21) Appl. No.: 12/218,342

(22) Filed: Jul. 14, 2008

(51) Int. Cl. G10G 7/02

(52) U.S. Cl. 84/454

(57) ABSTRACT

A stringed instrument tuner that detects vibrations of the string being played via an integrated circuit and displays the nearest musical note value and the deviation of that strings pitch relative to an in-tune reference pitch This tuner has a clothes pin like design that allows it to be easily mounted on a stringed instrument, such as a guitar, by squeezing the top legs of the device and applying pressure to the coil mechanism to exert force on the lower jaws so that that they open up to allow clamping and securement onto the instrument. The electronics housing is built into one of the legs of the clothes pin tuner adjacent to where the user squeezes the clothes pin with their thumb. The electronics housing contains an integrated circuit, battery, and LED display

### CROSS-REFERENCE TO U.S. PATENT DOCUMENTS

| | | |
|---|---|---|
| 3412638 | November 1968 | John W. Pease |
| 4899636 | February 1990 | Chiba, et al. |
| 5637820 | June 1997 | Wittman |
| 5877444 | March 1999 | Hine, et al. |

### STATEMENT REGARDING FEDERALLY SPONSORED RESEARCH OR DEVELOPMENT

NA

### BACKGROUND OF THE INVENTION

Tuners are required for stringed musical instruments (e.g., classical, accoustic or electric guitars) as changes in temperature can cause the wood to expand and contract, resulting in changes in pressure being applied to the strings and causing their pitch to deviate from their reference values. A guitar, for example, has six strings E-B-G-D-A-E from the highest pitched string to the lowest. Existing tuning devices for stringed instruments are often cumbersome to use and/or can fall off the instrument being tuned or slip out of the users hand. Reference to some of these inventions is provided below.

U.S. Pat. No. 4,899,636 (issued February 1990) disclosed a tuner that is mounted on the external surface of an instrument with a suction cup mechanism that determines pitch by sensing vibrations via a piezoelectric element in the integrated circuit. The problem with this approach is that suction cups require a flat plane to be attached and often lose suction and fall off over time.

US Patent Des 402,684 (February 1998) discloses a tuning devices that is mounted on a stringed instrument with a C-clamp like mechanism (similar to U.S. Pat. No. 3,412,638 November 1968) that sometimes falls off the instrument when one tries to actuate or rotate the display component for a more direct view of the viewing window.

U.S. Pat. No. 5,637,820 (June 1997) discloses a stringed instrument with a tuner built into the instrument as opposed to an independently mounted tuner and this approach has largely failed to be adopted.

### BRIEF SUMMARY OF THE INVENTION

A tuner that incorporates a clothes pin design for securing the device to a guitar or other stringed instrument. This clothes pin tuner incorporates an integrated circuit that is designed to detect vibrations of the string being played, display the note value of that string, and display the deviation of that string's pitch relative to an in-tune reference pitch.

Existing guitar tuners require the musician to manually plug-in to get an accurate reading or possess cumbersome technologies for mounting the device on the instrument. One device currently in the market requires the user to apply a great deal of force with their thumb to pull down a spring mechanism that opens the jaws of a C-clamp mounting mechanism. This device also has a semi-rigid electronics casing that is difficult to rotate so that the musician may view the LED window.

### BRIEF DESCRIPTION OF THE SEVERAL VIEWS OF THE DRAWING

FIG. 1 is a side view of the tuner that reveals a clothes pin like design

FIG. 2 is a frontal view of one of the legs of the tuner where the thumb is applied to squeeze the upper legs and allow the lower jaws to open. The LED display also appears on the front along with the mode, select and power buttons.

FIG. 3 is a rear view of the front leg appearing in FIG. 2. This is where the user can open the electronics housing to replace the battery and view the integrated circuit inside the device.

### DETAILED DESCRIPTION OF THE INVENTION

One proposed embodiment for the present invention is described below with reference to related drawings. The invention is a musical instrument tuner that is mounted on a stringed musical instrument each time the musician feels the need to tune.

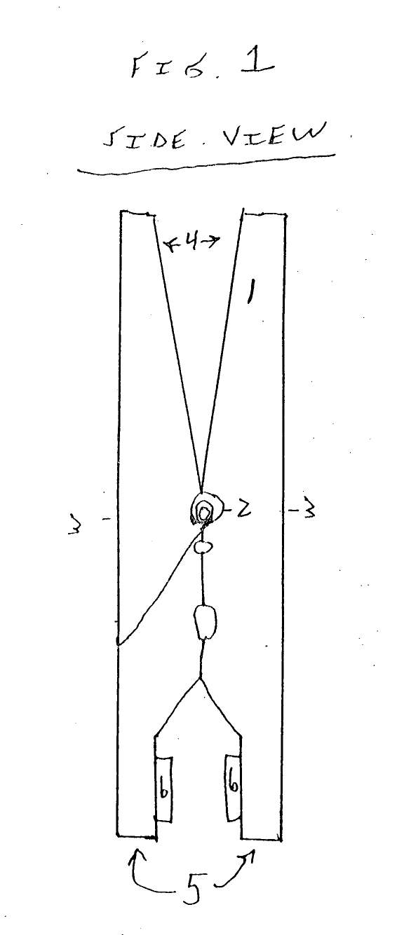

Referring to FIG. 1, the invention 1 has a clothes-pin design or Configuration to allow easy placement on and removal from the stringed instrument being tuned. One can see that the invention incorporates a coil or similar mechanism 2 that connects the two parallel sides 3 of the clothes pin. When the musician squeezes the two legs at the top of the clothes-pin together 4, the coil 2 applies mechanical force to open the jaws 5 at the bottom of the clothes-pin tuner to allow the clamp created to be placed on the head stock or another part of the stringed instrument. The user then stops squeezing the two legs at the top of the clothes pin tuner, which causes the lower jaws to close down on and secure to the instrument head stock.

The invention incorporates a cushion or pad 6 on the inner side of each jaw 5 to protect the instrument from being scratched by the tuner and to aide in securing or fastening the device to the musical instrument.

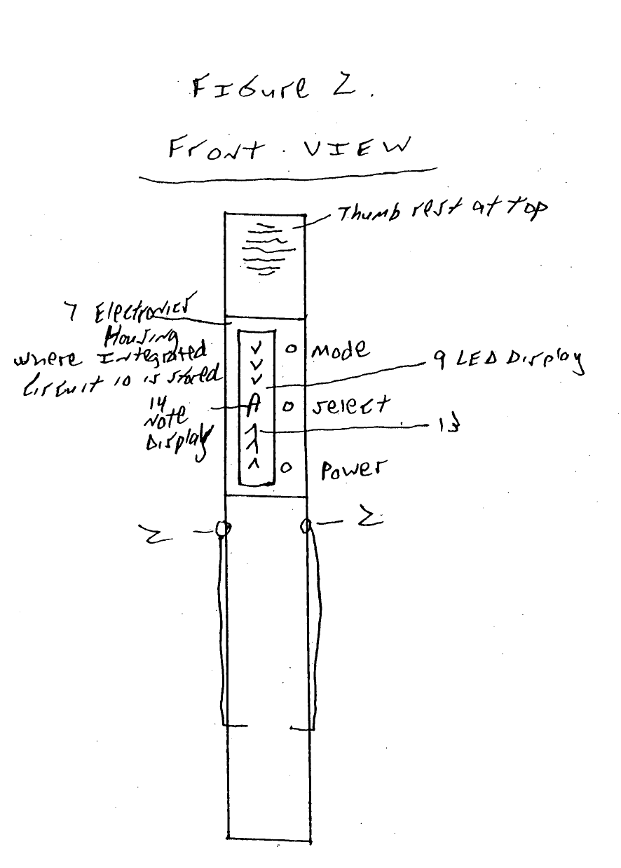

FIG. 2 demonstrates that the invention has an electronic circuitry Component or housing 7 that is built into the top of one of the parallel legs 3 of the tuner near where the musician squeezes the pin to open the lower jaws. This electronics housing 7 contains a power source (such as a lithium battery) 8, an LED display 9 and an integrated circuit 10 and can be pivoted to allow the user to have a direct view of the LED display 9 from his/her desired angle.

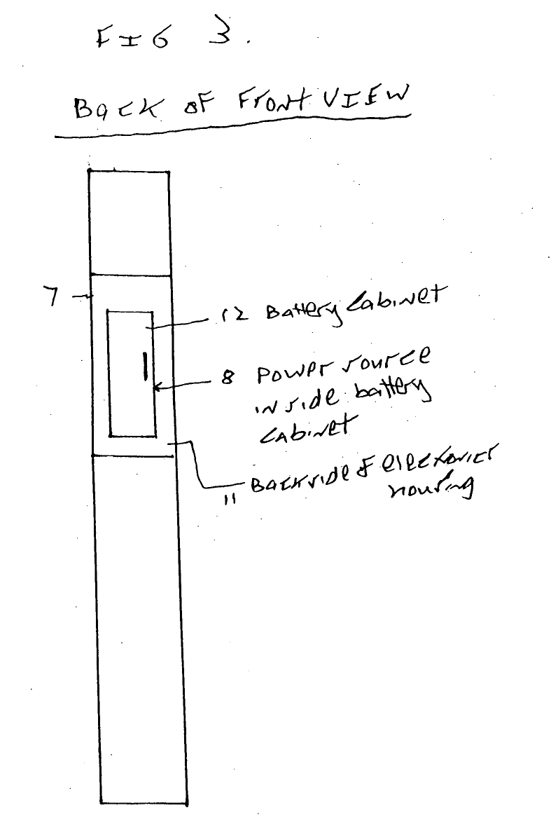

FIG. 3 reveals that the back side 11 of the electronics housing has a battery cabinet 12 for easy battery 8 replacement.

The electronics housing 7 contains an integrated circuit (chip) 10 that receives the vibration provided by the musical instrument string that is plucked through the tuner case and converts it into an electrical signal that corresponds to the strings frequency and note value. The integrated circuit 10 also stores reference values for the pitch of each of the twelve notes in the musical scale across up to seven octave ranges. The integrated circuit 10 compares the pitch value obtained from the string played to the nearest pitch reference value and displays that note on an LED display 9. The deviation of the pitch obtained from the reference note is displayed on the LED 9 using arrow or light indicators 13. The integrated Circuit 10 produces output signals that drive twelve indicator diodes on the display.

If the string is in tune with its pitch reference value, the integrated circuit 10 will send a signal that lights up an in-tune diode 14 on the display that shows the note played as well as a green in-tune indicator. All of the Indicator arrows or red diodes will also light up in a column on each side of the in-tune note diode indicator.

If the string is not in tune with its pitch reference value, the integrated circuit 10 will send a signal to alternative diodes that indicate whether the string is flat or sharp relative to its reference pitch. As a case in point, if the pitch is flat, the arrow indicators above the desired note on the viewing window will be displayed. Conversely, if the pitch is sharp, the arrow indicators below the desired note appearing at the middle of the display will light up.

What is claimed is:

1. A stringed instrument tuner that is independent of the instrument (not built into the instrument) and mounted on the instrument each time a musician wishes to tune, comprising:
A clothes-pin design for securing the tuner to the musical instrument head stock or other location.

2. the stringed instrument tuner described in claim 1 above with a detector sensing vibrations generated by an instrument string and converting them into a corresponding electrical pitch signal

3. the stringed instrument tuner described in claim 1 above with an integrated circuit that takes the electrical pitch signal generated by the stringed instrument and compares it to a set of pitch reference values stored in the devices memory. This integrated tuning circuit then determines which of the twelve notes in the musical scale is the closest to the electrical pitch signal generated and displays it on the viewing window (LED display.)

4. the stringed instrument tuner described in claim 1 above that has an LED window that displays the degree to which a string's pitch deviates from its closest reference value with two or more arrows or lights on each side of the note displayed to indicate the degree of sharpness or flatness

5. the stringed instrument tuner described in claim 1 above that has a mode, select and volume button on the electronics housing next to the LED display window.

6. the stringed instrument tuner decribed in claim 1 above that has bumpers made of rubber or an alternative material to prevent the jaws of the clothes pin tuner from scratching the musical instrument

7. the stringed instrument tuner described in claim 1 above that has an articulating electronics housing on the front leg of the clothes pin to allow the user to turn the device so that they can have a more direct view of the LED window where the note played is displayed

8. the stringed instrument tuner described in claim 1 with a battery and battery compartment for providing power to the device
